(19) United States
(12) Patent Application Publication
(10) Pub. No.: US 2008/0196073 A1
(43) Pub. Date: Aug. 14, 2008

(54) Image Data Communication Apparatus

(76) Inventors: Hiroshi Tango, Tokyo (JP); Hisayuki Ide, Tokyo (JP); Keita Kawakami, Tokyo (JP); Michisuke Shimodaira, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/922,499

(22) PCT Filed: Jun. 22, 2006
(86) PCT No.: PCT/JP2006/312497

§ 371 Date: Dec. 19, 2007

(30) Foreign Application Priority Data
Jun. 24, 2005 (JP) 2005-184649
Apr. 18, 2006 (JP) 2006-114118

(51) Int. Cl. H04N 7/173

(52) U.S. Cl. 725/109

(57) ABSTRACT

Disclosed is an image data communication apparatus for achieving real-time transmission of image data such as one compatible with an extended definition television using a plurality of communication lines having a transmission capacity equivalent to an ADSL system at a time. The data communication apparatus includes a data transmission section 10, gates AG and BG, and a data reception section 20. The data transmission section 10 packetizes original image data to be transmitted and assigns, to each packet 12, identification information 14 by which one packet can be distinguished from another so as to output generated packets. The gates AG and BG refer to the identification information 14 to distribute the packets output from the data transmission section 10 to different communication lines AN and BN based on previously set conditions. The data reception section 20 refers to the identification information 14 to rearrange the packets transmitted thereto via the plurality of communication lines AN and BN in a predetermined order and reproduces the original image data.

### BACKGROUND OF THE INVENTION

1. Field of the Invention

The present invention relates to an image data communication apparatus that transmits high-quality image data such as a High-Vision™ image using a packet communication line.

2. Description of the Related Art

Packetization of television image data allows distribution of a TV broadcasting service via the Internet connection. For example, a TV broadcasting service using an NTSC system can be transmitted via a broadband Internet connection using an ADSL service. That is, it is only necessary to carry simple broadcasting equipment to a shooting site and it is possible to distribute a live broadcast from all corners of the country. This eliminates the need to provide expensive equipment for relay broadcast conventionally used. That is, it is considered that the method of real-time relay broadcast for TV broadcasting service will be remarkably changed. Such a technique is disclosed in, e.g., Jpn. Pat. Appln. Laid-Open Publications Nos. 2003-296595 and 2004-221769.

However, the prior arts include the following problem to be solved.

High-image quality television broadcast systems such as a digital broadcasting system and High-Vision™ broadcasting system have now become popular, replacing a conventional TV broadcasting service using an NTSC system. In such high-image quality television broadcast systems, an extremely large amount data is transmitted and, therefore, it is difficult to perform real-time transmission via an ADSL broadband network. However, the ADSL system is a relatively inexpensive communication system and is now getting more and more popular nationwide. Further, the ADSL system costs significantly less than other communication systems. If a large-capacity communication line such as an optical fiber can be used, this problem is solved. However, when traffic is increased due to an increase of subscribers, communication speed decreases to lead to degradation of signal quality.

The present invention has been made to solve the above problem, and an object thereof is to provide an image data communication apparatus capable of transmitting high-quality image data such as one compatible with an extended definition television. Another object of the present invention is to provide an image data communication apparatus capable of maintaining sufficient communication speed even when traffic in a communication line is increased.

### SUMMARY OF THE INVENTION

To solve the above problems, an image data communication apparatus of the present invention is configured as follows.

<Configuration 1>

An image data communication apparatus comprises: a data transmission section which packetizes original image data to be transmitted and assigns, to each packet, identification information by which one packet can be distinguished from another and which indicates the order of packets to be rearranged so as to output generated packets; a gate which refers to the identification information to distribute the packets output from the data transmission section to different communication lines based on previously set conditions; and a data reception section which refers to the identification information to rearrange the packets transmitted thereto via the plurality of communication lines in the rearrangement order and reproduces the original image data.

Packets to be transmitted are forcibly distributed to a plurality of communication lines with the arrangement order assigned thereto. As a result, high-quality and large-capacity packet transmission becomes possible with small capacity communication lines.

<Configuration 2>

An image data communication apparatus comprises: a data transmission section which packetizes original image data to be transmitted and assigns, to each packet, an address indicating one of a plurality of destination port and identification information by which one packet can be distinguished from another and which indicates the order of packets to be rearranged so as to output generated packets; a gate which refers to the destination port address to distribute the packets output from the data transmission section to different communication lines connected respectively to the destination ports; and a data reception section which refers to the identification information to rearrange the packets transmitted via the plurality of communication lines and received by ports connected respectively to the communication lines in the rearrangement order and reproduces the original image data.

In order to forcibly distribute packets to different communication lines, the packets are transmitted with an address indicating one of a plurality of destination port assigned thereto.

<Configuration 3>

In addition to the above configurations, there is provided the image data communication apparatus wherein the gate receives inputs of all the packets output from the data transmission section and outputs only the packets that satisfy previously set conditions to the corresponding communication line.

Since the gate that forcibly distributes a packet is provided, packets can be distributed in accordance with the capacity of the communication line.

<Configuration 4>

In addition to the above configurations, there is provided the image data communication apparatus wherein the packet identification information is numeric data indicating the rearrangement order of packets, the gate provided for each communication line receives one packet at a time in the order indicated by the identification information in a periodical fashion and outputs the received packets to the communication line, and the data reception section rearranges the packets received by a port connected to the communication line in the order indicated by the identification information and reproduces the original image data.

Packets can be equally distributed to a plurality of communication lines according to a given rule, making it easy for the receiving side to perform rearrangement control.

<Configuration 5>

In addition to the above configurations, there is provided the image data communication apparatus wherein the gate provided for each communication line outputs only packets that include a destination port address specified by the data transmission section to the communication line and discards packets that do not satisfy the above condition.

This configuration narrows down the behavior of packets to “PASS” and “DISCARD”, making it easy for the gate to perform packet distribution control.

<Configuration 6>

In addition to the above configurations, there is provided the image data communication apparatus wherein the gate receives one packet at a time in the order indicated by the identification information in a periodical fashion and outputs the received packets to the communication line, and the data reception section rearranges the packets received by the port in the order indicated by the identification information and reproduces the original image data.

This configuration also simplifies the packet distribution control.

<Configuration 7>

In addition to the above configurations, there is provided the image data communication apparatus further comprising: a storage unit which stores band information indicating the transmission band of the communication line; and a distribution ratio controller which refers to the band information to control the gate so as to distribute the packets at a ratio corresponding to the ratio between the transmission bands of respective communication lines.

Distribution of packets performed in the gate is made based on the ratio between transmission bands of respective communication lines, making burdens on the respective communication lines equal to one another, so that the data reception section receives all packets within the time range in which the packets can be rearranged.

<Configuration 8>

In addition to the above configurations, there is provided the image data communication apparatus further comprising: a congestion index acquisition unit which acquires current congestion index of the communication line; a storage unit which stores the congestion index; and a distribution ratio controller which refers to the congestion index to control the gate such that a smaller packet distribution ratio is assigned to a communication line being more congested.

In the above configuration, the image data communication apparatus monitors communication lines and acquires the congestion indexes thereof. Although the congestion index may arbitrarily be defined, it is preferable to use a numeric value that represents the degree of congestion as the index. Since packet distribution is controlled such that a smaller packet distribution ratio is assigned to a communication line being more congested, the data reception section receives all packets within the time range in which the packets can be rearranged.

<Configuration 9>

In addition to the above configurations, there is provided the image data communication apparatus wherein the data reception section includes: an error detection section which detects the code error of the received packets; a counter which periodically counts the number of code errors detected by the error detection section at regular time intervals; and an error information report section which transmits error information including the code error numbers counted by the counter to the data transmission section, and the data transmission section includes: a report reception section which receives the error information from the error information report section; and a distribution ratio controller which refers to the number of code errors of the packets in the communication lines at regular time interval to control the gate such that a smaller distribution ratio is assigned to a communication line having a larger code error rate.

The packet transmission rate is virtually decreased by the amount corresponding to error correction time in a communication line in which code errors frequently occur. In order to cope with this, a report of the number of code errors occurring within a given time is transmitted from the data reception section to data transmission section. The data transmission section refers to the report and controls packet distribution such that a smaller distribution ratio is assigned to a communication line having a larger code error rate. This optimizes packet distribution ratio in real-time.

<Configuration 10>

In addition to the above configurations, there is provided the image data communication apparatus wherein a communication line in which the number of code errors exceeds a threshold value is excluded from packet distribution destination lists.

There is a possibility that a communication failure is currently occurring or will occur in a communication line in which the number of code errors exceeds a threshold value. Therefore, the communication line in which the number of code errors exceeds a threshold value is previously excluded from packet distribution destination lists to thereby prevent a failure of reproduction of original image data.

### BRIEF DESCRIPTION OF THE DRAWINGS

FIG. 1 is a block diagram showing an image data communication apparatus according to Example 1;

FIG. 2 is a block diagram showing an image data communication apparatus according to Example 2;

FIG. 3 is a block diagram showing an image data communication apparatus according to Example 3;

FIG. 4 is a block diagram showing an image data communication apparatus according to Example 4; and

FIG. 5 is a block diagram showing an image data communication apparatus according to Example 5.

### DETAILED DESCRIPTION OF THE PREFERRED EMBODIMENTS

In the present invention, a plurality of ADSL communication lines are utilized at a time to perform real-time transmission of high-quality image data such as one compatible with an extended definition television. Hereinafter, an embodiment of the present invention will be described using specific examples.

### EXAMPLE 1

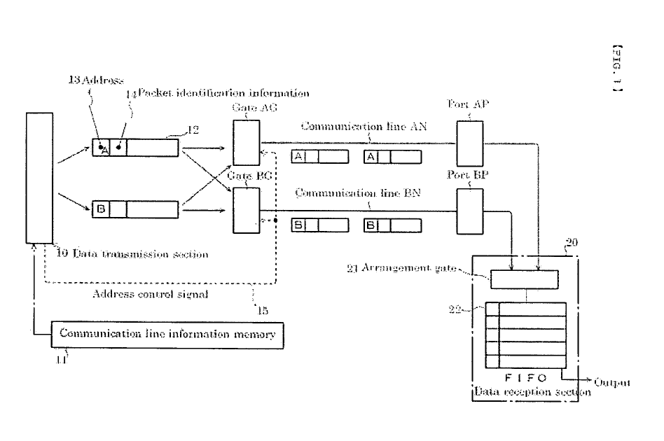

FIG. 1 is a block diagram showing an example of an image data communication apparatus.

A data transmission section 10 shown in FIG. 1 holds original image data to be transmitted. Accordingly, a not shown components such as image data generation unit, a storage unit, and a transmitter are provided in the data transmission section 10. The original image data mentioned here is data obtained by shooting an object with a TV camera and the like. That is, a TV camera or video equipment serves as the data generation unit. The entire or part of the original image data is temporarily stored in the data transmission section 10 and sequentially read out for output.

The original image data output from the data transmission section 10 is transmitted to a data reception section 20. The data transmission section 10 packetizes original image data for transmission. Each packet 12 includes a destination port address 13. Further, each packet 12 includes packet identification information 14 by which one packet can be distinguished from another and which indicates the order of packets to be rearranged. The packet identification information 14 can be number or symbol. The packet identification information 14 includes order information by which packets can be rearranged to their original order. This allows reproduction of the original image data.

A communication line shown in FIG. 1 connects the data transmission section 10 and data reception section 20. The data transmission section 10 acquires information concerning the communication line from a communication line information memory 11. As shown in FIG. 1, the communication line information memory 11 stores information indicating, for example, that a port AP is connected to the output side of a communication line AN or that a port BP is connected to a communication line BN. In this example, two communication lines AN and BN are used to transmit image data. The communication lines AN and BN constitute an ADSL network, respectively. The transmission rate thereof is set at, e.g., 12 Mbps.

A gate AG is connected to the input terminal of the communication line AN. A gate BG is connected to the input terminal of the communication line BN. Both the Gates AG and BG receive all packets output from the data transmission section 10. The gate AG receives an address control signal 15 from the data transmission section 10. The address control signal 15 represents, e.g., the port address of the port AP. The gate AG compares a port address 13 of a received packet 12 and address control signal 15. The gate AG outputs only a packet which is destined for the port AP and whose port address 13 matches the address control signal 15 to the communication line AN. Other packets are discarded on the input side of the gate AG. The gate BG operates in the same manner as the gate AG. The address control signal 15 that the gate BG has received from the data transmission section 10 represents, e.g., the port address of the port BP. Accordingly, the gate BG outputs only a packet destined for the port BP to the communication line |BN|. Other packets are discarded on the input side of the gate BG.

As described above, gates AG and BG refer to the packet identification information 14 assigned to the packet 12. The gates AG and BG further have a function of forcibly distributing packets to different communication lines based on set conditions. The packet group that has been output from the data transmission section 10 is divided into two groups by the gates AG and BG, followed by being transmitted to the communication line AN or communication line BN. It is preferable that packets be distributed forcibly and regularly according to a certain rule. This makes it easy to perform rearrangement processing of packets on the reception side easy.

The packet groups transmitted to the ports AP and BP are input to the data reception section 20. The data reception section 20 includes an arrangement gate 21 and a FIFO (first-in first-out) memory 22. The arrangement gate 21 reads out the packet identification information 14 of packets received from the port AP and port BP and stores the packets in the FIFO memory 22 according to the rearrangement order of packets.

In this example, it is assumed that the communication lines AN and BN are lines in which quality and transmission order of packets to be transmitted are guaranteed. That is, packets to be transmitted are output in the order in which the packets are input from the gate AG or BG. Data errors are corrected on the output side of the communication lines AN and BN. It is assumed that overtaking of packets is not allowed in the communication lines AN and BN. The packet identification information 14 includes, e.g., numeric information indicating the ascending order. Therefore, packets can automatically be rearranged in the data reception section 20.

Packets are input to the arrangement gate 21 at an arbitrary timing via the ports AP and BP. There is a case where these packets are transmitted in an asynchronous manner or where the transmission rate may differ from one packet to another. In either case, the arrangement gate 21 compares the identification information 14 of a pair of packets simultaneously input thereto from the ports AP and BP. In this case, a packet having a smaller number is input to the FIFO memory 22 in advance of another. With the above operation, all packets are input to the FIFO memory 22 in the ascending order in terms of the packet identification information 14 and arranged therein. Theses packets are output from the output side of the FIFO memory 22 and are transferred to, e.g., a TV display.

If the timing at which the arrangement gate 21 reads out one of the pair packets output from one port is delayed, the packet may be discarded. Therefore, it is preferable that a buffer memory have a capacity enough to hold packets that have passed through either of ports AP or BP in the input order by the time period necessary and sufficient for rearrangement processing. To minimize the reception timing gap, it is preferable to employ the following method. When, for example, packets having numbers (indicating the rearrangement order) [1], [2], [3], [4], [5], [6], . . . are transmitted, all the packets are output from the data transmission section |10| in the rearrangement order. Thereafter, the packets are divided into two groups: one having even numbers and another having odd numbers. Then, according to the identification information, packets whose numbers are [1], [3], [5], . . . are transmitted via the gate AG and packets whose numbers are [2], [4], [6], . . . are transmitted via the gate BG. As described above, the timing at which packets are transmitted via a plurality of gates on the output side and identification information of the packets passing through the gates are optimized. As a result, packets can be received in the rearrangement order on the reception side.

With the above configuration, a transmission path having a total transmission capacity of 24 Mbps can be realized by using two ADSL communication lines each having a transmission capacity of 12 Mbps. As a result, it is possible for the data transmission section 10 to packetize high-quality image data such as one compatible with a High-Vision™ broadcasting and transmit the packetized image data in real time to the data reception section 20. The ADSL communication line cannot always offer the intended transmission rate. Therefore, it is preferable to previously measure the transmission rate of respective communication lines and prepare the appropriate number of communication lines so that total transmission capacity does not fall below 20 Mbps. Further, it is preferable to distribute an appropriate amount of packets to each transmission line according to the transmission capacity thereof. That is, it is preferable to make the number of packets to be distributed to each communication line proportional to the transmission rate thereof. By arranging the packets transmitted to the data reception section 20 in the ascending order with the above configuration, original image data can faithfully be produced.

### EXAMPLE 2

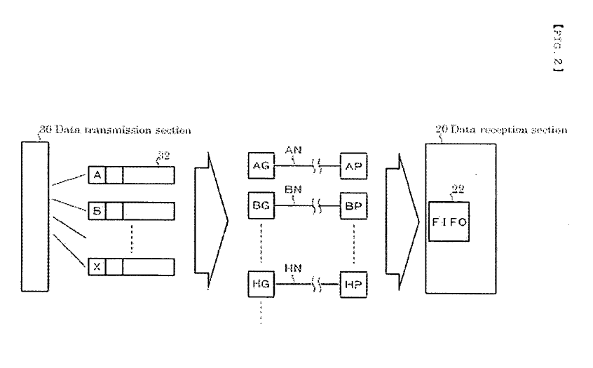

FIG. 2 is a block diagram showing another example of the present invention.

This block diagram simplifies content that overlaps between FIGS. 1 and 2. In the example shown in FIG. 1, two ADSL communication lines are used to secure a predetermined transmission capacity. In this example, a given plurality of communication lines are used to achieve the same object. A plurality of packets 32 are output from a data transmission section 30. These packets 32 are distributed to a plurality of communication lines AN to HN. It is assumed that substantially the same transmission rate is set in these transmission lines. In this example, all packets are output from the data transmission section 30 in the rearrangement order, i.e., in the order of [1], [2], [3], [4], [5], [6], . . . . The packets having identification information of [1], [2], [3], [4], [5], [6], . . . are serial/parallel converted to be supplied to gates AG, BG, CG, DG, EG and transmitted to the data reception section 20 in this order. The data reception section 20 collects the packets transmitted thereto via the plurality of communication lines, rearranges them, and stores them in the FIFO memory 22. With the above configuration, real-time transmission of high-quality image data can be achieved.

The packet identification information includes, e.g., numeric data indicating the rearrangement order of packets. The gate provided for each communication line receives one packet at a time in the order indicated by the identification information in a periodical fashion. Thus, it is possible to automatically rearrange the packets on the reception side simply by picking up the packets from the communication lines in the same order as transmission side.

### EXAMPLE 3

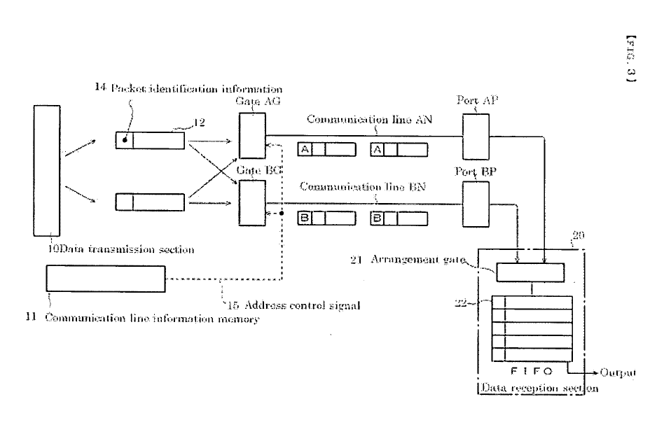

FIG. 3 is a block diagram showing still another example of the present invention.

In this example, a packet 12 that includes only the packet identification information 14 is output from the data transmission section 10. The gates AG and BG acquire information concerning the communication line from the communication line information memory 11. In this example, two communication lines are provided. Control information stored in the communication line information memory 11 indicates a procedure of transmitting packets whose packet identification information indicates even number to the communication line AN and transmitting packets whose packet identification information indicates odd number to the communication line BN. The control information is supplied to the gates AG and BG. All the packets generated by the data transmission section 10 are distributed to respective communication lines according to the above procedure. Subsequent packet processing performed in the data reception section 20 is the same as that described in the above examples. The performance of the communication lines that transmit image data is previously known. If the performance information is stored in the communication line information memory 11, the data transmission section 10 or gates AG, BG, . . . is controlled and the packets generated in the data transmission section 10 can be distributed in accordance with the number of communication lines and transmission capacity of the communication lines.

Although an ADSL line is used in the above examples, a broadband network line such as a cable TV network may be used. Further, an optical fiber line may be employed. In either communication line, an image obtained by shooting an object at various regions can be transmitted in real-time to a broadcast station by utilizing the image data communication apparatus and by installing a relay unit at regions where there is no broadcast station. Further, it is possible to adopt a method that provides a required number of ADSL lines at the shooting site or the like and transmits image data to the ADSL lines from the data transmission section. The gates AG and BG need not be integrated with each other but may be separated from each other. Therefore, it is possible to achieve real-time transmission of High-Vision™ image data by borrowing ADSL lines utilized in two or three houses.

Any rearrangement method of packets can be used in the data reception section 20. It is possible to pick up packets in the order indicated by the packet identification information by mechanically performing given sorting processing on the reception side as long as the packet transmission order between communication lines is guaranteed. Even if any error occurs and packets are not arranged in the right order, a given error check mechanism allows reproduction of the packets. This allows high-quality transmission of uncompressed high-quality image data of 1.5 GHz. In an ADSL line, multicast transmission is not allowed in order to prevent traffic from being overloaded in the network. However, the present invention can produce an effect equivalent to the case of using a large-capacity communication line with a unicast transmission. According to the present invention, high-quality transmission of high-quality image data can be achieved at a cost about one-tenth of that required in the case of securing one communication line guaranteeing a transmission capacity of 100 Mbps.

### EXAMPLE 4

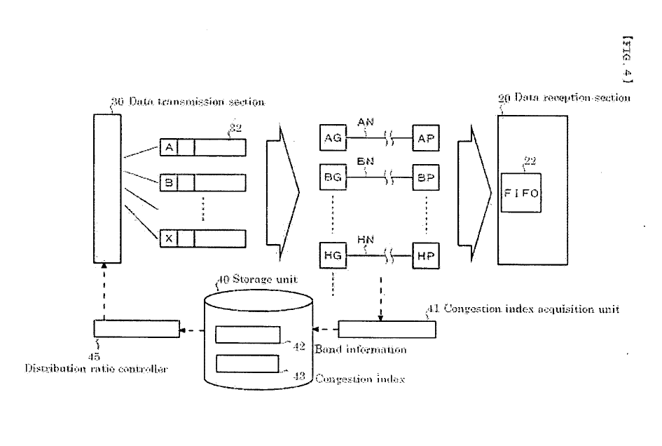

FIG. 4 is a block diagram showing an image data communication apparatus of Example 4.

As described in the above examples, the image data communication apparatus distributes a packet group to a plurality of communication lines for transmission. If the plurality of communication lines have the same function and quality, it is only necessary to distribute the packet group in an equitable way. Actually, however, there are different environmental factors between the communication lines, so that the function and quality may vary between the communication lines. For example, there is a case where the data transmission rate of one communication line is significantly lower than that of another communication line. In this case, a long time is taken for the data reception section 20 to receive all the packets required for packet rearrangement. This prevents real-time transmission of high-quality video image.

To cope with this problem, the image data communication apparatus of this example monitors a plurality of communication lines to be used to thereby acquire a congestion index. A congestion index acquisition unit 41 shown in FIG. 4 periodically acquires a congestion index indicating the congestion degree of each communication line. For example, congestion index “5” indicates the maximum congestion degree and congestion index “1” indicates a state where there remains sufficient capacity. As described above, the congestion degree may be represented with five-grades of evaluation. The acquired congestion index is written into a storage unit 40 provided in the data transmission section 30. The congestion index 43 written into the storage unit 40 includes a list of the latest congestion indexes of all communication lines.

A distribution ratio controller 45 refers to the congestion index 43 stored in the storage unit 40 to calculate the distribution ratio of packets and notifies the data transmission section 30 of the calculation result. More specifically, assume that two communication lines are used and that congestion index “4” is assigned to one communication line and congestion index “2” is assigned to the other communication line. In this case, since traffic of the former communication line is more congested, the distribution ratio of packets between two communication lines is set to 1:2. That is, the amount of packets to be distributed to the congested communication lines is reduced; on the other hand, the amount of packets to be distributed to the less-congested communication lines is increased. As a result, the data reception section 20 can receive all the packets required for packet rearrangement form a plurality of communication lines substantially simultaneously.

A transmission band may differ depending on the communication line in some cases. For example, even in the case where the same ADSL system is adopted, some communication lines have a transmission band of 10 Mbps, while other communication lines have a transmission band of 30 Mbps. In order to cope with this, band information 42 indicating the transmission band of respective communication lines is previously stored in the storage unit 40. The band information is, e.g., a numeric value directly representing the transmission band of a communication line. The distribution ratio controller 45 refers to the band information 42 to calculate the distribution ratio of packets and notifies the data transmission section 30 of the calculation result. It is preferable to distribute packets at a ratio substantially corresponding to the ratio between the transmission bands of respective communication lines. For example, in the case where two communication lines are used and where one communication line has a transmission band of 20 Mbps and the other has a transmission band of 10 Mbps, the packet distribution ration is set to 2:1. With this setting, packets can reach the data reception section 20 at substantially the same speed. As a result, the data reception section 20 can receive all the packets required for packet rearrangement from a plurality of communication lines substantially simultaneously.

### EXAMPLE 5

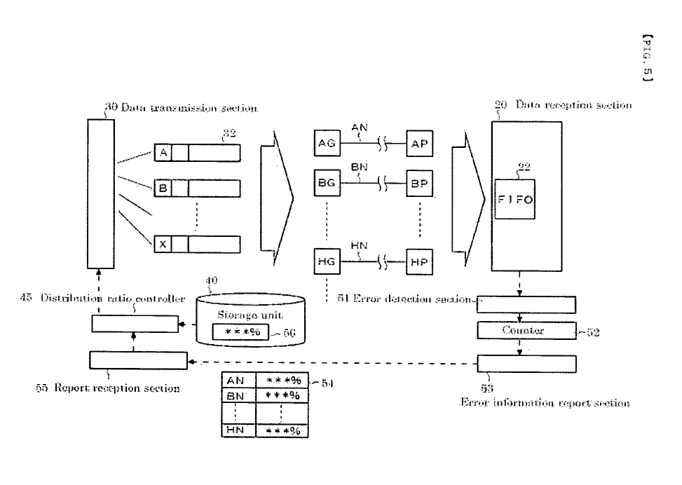

FIG. 5 is a block diagram showing an image data communication apparatus of Example 5.

The apparatus shown in FIG. 5 has, on its data reception side, an error detection section 51, a counter 52, and an error information report section 53. The error detection section 51 detects the code error of packets received by the data reception section 20. The counter 52 counts the number of code errors detected by the error detection section 51. For example, the counter 52 counts the number of code errors every one minute. The error information report section 53 periodically reads out the accumulated number of error codes from the counter 52. After the number of code errors has been read out, the counter 52 is reset to zero. After that, the counter 52 restarts counting the number of code errors.

The error information report section 53 integrates the read code error numbers with information indicating the readout time or the like to generate error information 54. The error information 54 is transmitted to a report reception section 55 provided in the data transmission section 30 side. The error information 54 is data indicating the number of the occurrences of code errors in a given period of time in each line. Alternatively, the error information 54 indicates a rate of occurrence of code errors per a given amount of packets. FIG. 5 shows the latter case. The distribution ratio controller 45 refers to the error information 54 received by the report reception section 55 to calculate the distribution ratio of packets and notifies the data transmission section 30 of the calculation result.

The distribution ratio controller 45 controls distribution of packets such that a smaller distribution ratio is assigned to a communication line having a larger code error rate. More specifically, the distribution ratio controller 45 monitors the code error rate in each communication line and, when the code error rate exceeds N %, reduces the packet distribution amount by 20%. At this time, overflowed packets are equally distributed to other communication lines. As a result, the data reception section 20 can receive all the packets required for packet rearrangement from a plurality of communication lines substantially simultaneously. Further, a threshold value 56 of code error numbers is stored in the storage unit 40. There is a strong possibility that a communication failure occurs in a communication line in which the number of code errors exceeds the threshold value 56. If a communication failure occurs, packet rearrangement becomes impossible to fail in real-time transmission of a video image. Therefore, the distribution ratio controller 45 automatically excludes a communication line in which the number of code errors exceeds the threshold value from packet distribution destination lists. If the number of communication lines to be used allows, it is possible to perform the above control without placing an enormous burden on other communication lines.

What is claimed is:

1. An image data communication apparatus comprising:
a data transmission section which packetizes original image data to be transmitted and assigns, to each packet, identification information by which one packet can be distinguished from another and which indicates the order of packets to be rearranged so as to output generated packets;
a gate which refers to the identification information to distribute the packets output from the data transmission section to different communication lines based on previously set conditions; and
a data reception section which refers to the identification information to rearrange the packets transmitted thereto via the plurality of communication lines in the rearrangement order and reproduces the original image data.

2. The image data communication apparatus according to claim 1, wherein
the packet identification information is numeric data indicating the rearrangement order of packets,
the gate provided for each communication line receives one packet at a time in the order indicated by the identification information in a periodical fashion and outputs the received packets to the communication line, and
the data reception section rearranges the packets received by a port connected to the communication line in the order indicated by the identification information and reproduces the original image data.

3. An image data communication apparatus comprising:
a data transmission section which packetizes original image data to be transmitted and assigns, to each packet, an address indicating one of a plurality of destination port and identification information by which one packet can be distinguished from another and which indicates the order of packets to be rearranged so as to output generated packets;
a gate which refers to the destination port address to distribute the packets output from the data transmission section to different communication lines connected respectively to the destination ports; and
a data reception section which refers to the identification information to rearrange the packets transmitted via the plurality of communication lines and received by ports connected respectively to the communication lines in the rearrangement order and reproduces the original image data.

4. The image data communication apparatus according to claim 3, wherein
the gate receives inputs of all the packets output from the data transmission section and outputs only the packets that satisfy previously set conditions to the corresponding communication line.

5. The image data communication apparatus according to claim 4, wherein
the gate provided for each communication line outputs only packets that include a destination port address specified by the data transmission section to the communication line and discards packets that do not satisfy the above condition.

6. The image data communication apparatus according to claim 4, wherein
the gate receives one packet at a time in the order indicated by the identification information in a periodical fashion and outputs the received packets to the communication line, and
the data reception section rearranges the packets received by the port in the order indicated by the identification information and reproduces the original image data.

7. The image data communication apparatus according to claim 6, comprising:
a storage unit which stores band information indicating the transmission band of the communication line; and
a distribution ratio controller which refers to the band information to control the gate so as to distribute the packets at a ratio corresponding to the ratio between the transmission bands of respective communication lines.

8. The image data communication apparatus according to claim 6, comprising:
a congestion index acquisition unit which acquires current congestion index of the communication line;
a storage unit which stores the congestion index; and
a distribution ratio controller which refers to the congestion index to control the gate such that a smaller packet distribution ratio is assigned to a communication line being more congested.

9. The image data communication apparatus according to claim 6, wherein
the data reception section includes:
an error detection section which detects the code error of the received packets;
a counter which periodically counts the number of code errors detected by the error detection section at regular time intervals; and
an error information report section which transmits error information including the code error numbers counted by the counter to the data transmission section, and
the data transmission section includes:
a report reception section which receives the error information from the error information report section; and
a distribution ratio controller which refers to the number of code errors of the packets in the communication lines at regular time interval to control the gate such that a smaller distribution ratio is assigned to a communication line having a larger code error rate.

10. The image data communication apparatus according to claim 9, wherein
a communication line in which the number of code errors exceeds a threshold value is excluded from packet distribution destination lists.
